(19) United States
(12) Patent Application Publication
(10) Pub. No.: US 2013/0199080 A1
(43) Pub. Date: Aug. 8, 2013

(54) Hook assembly with interchangeable fishing lure bodies.

(71) Applicant: Steven J. Woosley, Fort Myers, FL (US)

(72) Inventor: Steven J. Woosley, Fort Myers, FL (US)

(21) Appl. No.: 13/368,034

(22) Filed: Feb. 7, 2012

(51) Int. Cl. A01K 85/00

(52) U.S. Cl. 43/42.36

(57) ABSTRACT

A fishing lure system which has removable and interchangable lure bodies on a hook assembly. The hook assembly has a means of attaching the fishing line at one end and for attaching the hook or hooks. At the rear end of the hook assembly on the main body is a raised positive stop lug, which prevents it from sliding through the lure body. The lure body/bodies having a bore extending through the lure body in equal size and length to the main portion of the hook assembly. In addition to the bore a slot is provided from the bore to the bottom of the lure along the length of the lure. The slot being a smaller width than the bore as to provide a passageway for the fishing line to pass through and a passageway for any forward positioned hooks on the hook assembly.

### FIELD OF INVENTION

The invention relates to fishing lures and particularly to fishing lures having interchangable body styles, shapes, and/or colors.

### BACKGROUND OF THE INVENTION

In the field of sport fishing it is commonly accepted that fish of all species are attracted to different colors on any given day, not only colors but also action and style of fishing lures. This attraction can change on a daily and an hourly basis. It is imperative that the angler adapt the fishing lure to the situation if he/she wishes to catch fish consistently. This generally requires the present lure the angler is using to be detached from the fishing line, and the selected lure to be tied to the fishing line. This also requires that the angler must have a large selection of many lures in different shapes, styles, and color. This means a considerable investment by the angler, most lures have hooks already attached to each lure at the time of purchase. The cost of each hook and associated terminal tackle on each lure drives the price up. Another problem of a large selection of fishing lures with attached hooks is a storage problem. If the lures are stored separately of one another it takes up allot of valuable space on a sometimes confined space on a fishing vessel. If the lures with attached hooks are stored together to conserve space, it creates another problem of lure entanglement because of the multiple hooks. This takes alot of valuable time to untangle the lure to retie. A snap type swivel could be used to cut down the time it takes to retie a fishing lure, but most anglers prefer not to use them. Preferring instead, a direct fishing line attachment to the lure for strength. Also the snap swivel detracts from the aesthetic appeal of the fishing lure, and could change the lures action. Multiple attempts to simplify the fishing lure changing process have been made, and most systems provide a viable solution. But they do possess some faults, such as multiple parts to change, complicated assembly options including the need for tools, and weak mechanical links which are subject to failure under the stress of a hooked fish.

### OBJECTS, FEATURES, AND ADVANTAGES OF THE INVENTION

An object of this invention is to provide a fishing lure system with interchangable lure bodies of different styles, actions, and/colors on a removable hook assembly that is attached to a fishing line or leader.

Another object of this invention is to provide a simple method of changing the lure style, action, and/or color without having to detach the existing lure from the fishing line and retie a new lure style, action, and or color to the fishing line.

Another object of this invention is to provide a strong and direct fishing line or leader connection to the fishing lure when a fish is hooked. When a fish is hooked on a fishing lure, a tremendous amount of stress is inflicted on the fishing lure by struggling fish. By using the hook assembly all of the associated stress will be directed to the hook assembly and not the lure body. This will provide a better chance of landing the hooked fish.

Another object of this invention is that the lure bodies can be stored in various compact spaces without entanglement of hooks or fear of unintentional hooking of other lures and materials.

A feature of this invention is that many fishing lure bodies of different style, action, and or color may be attached to one hook assembly.

Another feature of this invention is that the lure bodies may be formed or constructed of various materials to alter the characteristics of the lure bodies such as buoyancy and action.

An advantage of this invention is that the lure bodies themselves may be produced and obtained at lower costs due to the fact that each lure body does not have to incur the cost of the hooks and associated terminal tackle. The hook assembly which would not have to be purchased with each lure body would incur the cost of the hooks and associated terminal tackle.

Another advantage of this invention is the lure bodies and hook assembly could be injection molded of plastic materials to lower the production costs.

These and other features and advantages will be apparent upon further review of the description of the preferred embodiment.

### BRIEF DESCRIPTION OF THE DRAWINGS

FIG. 1 shows the preferred internal component of the hook assembly. This part of the hook assembly is fixed into the hook assembly and is not removable.

FIG. 2 shows the complete hook assembly.

FIG. 3 shows a frontal view of the hook assembly.

FIG. 4 shows a side view of a generic lure body without the hook assembly inserted.

FIG. 5 shows a side view of a generic lure body with the hook assembly inserted into the lure body.

FIG. 6 shows a cross sectional view of the generic lure body in FIG. 4 taken along line 5 without the hook assembly inserted into the lure body, in which in particularly shows the longitudal bore in communication with the longitudal slot.

FIG. 7 shows a frontal view of a generic lure body.

FIG. 8 shows a side view of a generic lure body with a dive plane.

FIG. 9 shows a frontal view of a generic lure body with a dive plane showing the preferred slot in the dive plane in communication with the longitudal slot to provide line pass through.

FIG. 10 shows a three dimensional cross sectional view of the lure body taken along line 5 without the hook assembly inserted into the lure body, in which particularly shows the longitudal bore in communication with the longitudal slot.

### DETAILED DESCRIPTION

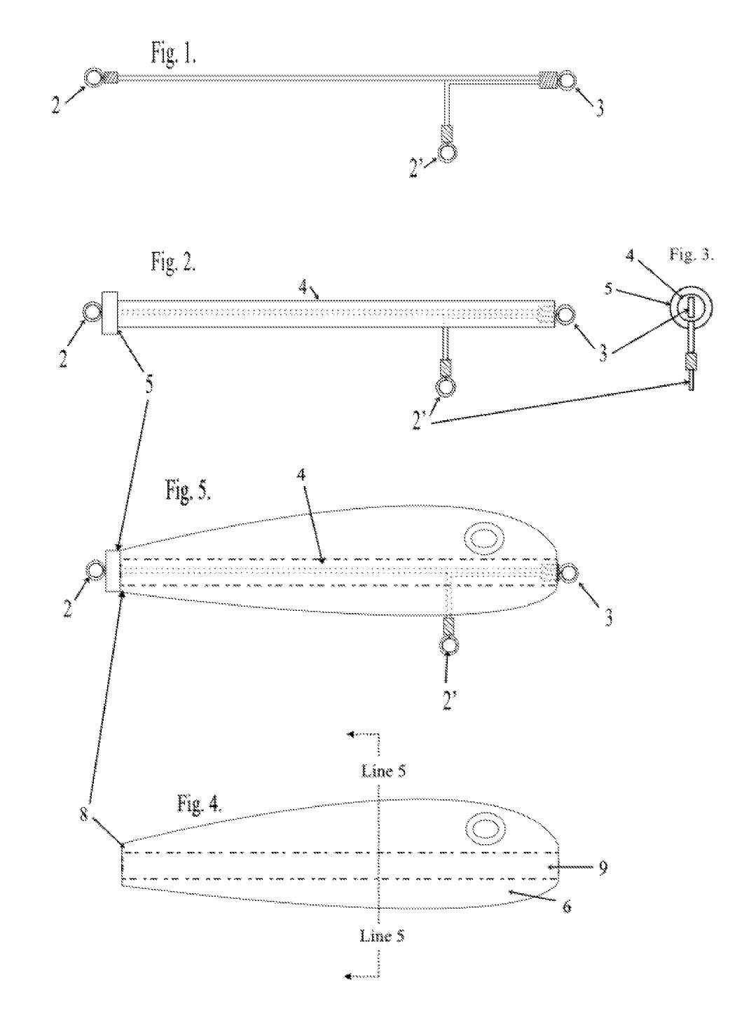

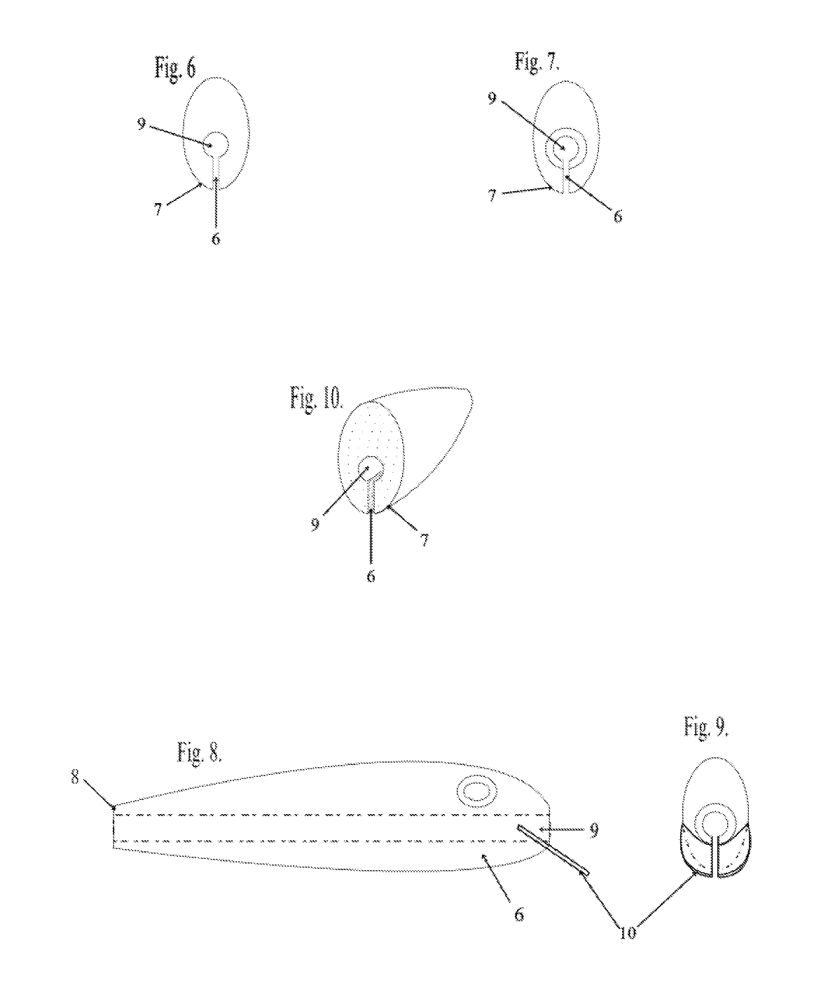

Referring to the drawings showing the preferred embodiments of the invention are illustrated by way of examples in FIG. 1 through FIG. 9. In specific reference to FIG. 1-FIG. 3 show the preferred hook assembly. The hook assembly is provided with a means 1 for attaching hooks 2 and 2′ of any type, and a means of attaching fishing line or leader 3. Which is encased in the hook assembly shroud 4 and becomes one assembly referred to as the hook assembly. Which also has a raised positive stop lug 5 at the rear of the main portion of the hook assembly 4 that will come to rest at the rear of the lure body 8 when inserted to the longitudal bore 9 of the lure body 7. The hook assembly 4 is generally cylindrical, but not limited to, in shape and is equal or slightly smaller in diameter to the longitudal bore 9. Extending from the longitudal bore 9 to the outer surface of the lure body 7 is the longitudal slot 6 which allows the fishing line or leader to pass through the lure body 7 without having to have the fishing line or leader detached from the hook assembly 4 and to allow the forward hook attachment 2′ to pass into the lure body 7. The longitudal slot 6 is preferably smaller in size of width than the longitudal bore 9 and extends the length of the lure body 7 and along the entire length of the longitudal bore 9.

When an angler wishes to remove a lure body 7 from the hook assembly 4, said angler simply grasps the hook assembly 4 at the raised positive stop lug 5 with one hand. Then with the other hand said angler grasps the lure body 7 typically at the center or front. Then slides the raised positive stop lug 5 away from the lure body 7. The hook assembly 4 will slide out from the longitudal bore 9. When the hook assembly clears the lure body 7 the fishing line or leader attached to the means for fishing line or leader attachment 3 will remain in the longitudal bore 9. Then said angler will lift the lure body 7 away from the fishing line or leader thus passing through the longitudal slot 6 and become separated from the hook assembly 4 and the fishing line or leader. Then a new or different lure body 7 of different style, action, and or color may be selected and installed on the hook assembly 4 by grasping with one hand the raised positive stop lug 5 and the lure body 7 with the other hand. Then placing the lure body 7 onto the fishing line or leader with the fishing line or leader passing through the longitudal slot 6 and into the longitudal bore 9. And inserting the means of fishing line or leader attachment 3 into the rear opening of the longitudal bore 9 and aligning the forward means of hook attachment 2′ with the longitudal slot 6 continuing inserting the hook assembly 4 until the raised positive stop lug 5 meets with the rear of the lure body 8. The completed fishing lure is then ready to be fished.

Reference to the lure body 7 in this description is of generic form. The lure body 7 may be of any shape and size and configured for any action and or color. Also in reference to the fishing lure body 7 any previously fabricated or manufactured fishing lure body designs could be made to be used with this invention including future designs of fishing lure bodies. The preferred embodiment of this invention is also not limited to just hard body fishing lures, but may also include soft body lure designs incorporated into the scope of this invention.

In reference to lipped fishing lure bodies which have a dive plane attached to the forward end of the lure body so as to make the lure body to dive to specific depths dependant on the dive plane size and shape. This style and or action type of lure body may also be modified to incorporate the scope of this invention, by continuing the longitudal slot 6 into and through the attached dive plane or lip as it is sometimes called shown in FIG. 8 and FIG. 9. Since the modified dive plane is fixed to the lure body no other parts such as extra dive planes are needed as in prior art. Thus simplifying the invention.

It will also be understood that while the form of the invention here in shown and described is a preferred embodiment of this invention, it is not intended to illustrate all possible forms thereof. And that the words used are not used as limitations, and various alterations may be made without departing from the scope of this invention.

What is claimed:

1. A fishing lure comprising of and in combination of
a. A hook assembly having an elongated shape which within has a means for attaching fishing line or leader at one end, and means of attaching one hook or more hooks to a portion of the hook assembly. And at the opposite end of the hook assembly from the means of fishing line or leader attachment on the main portion of the hook assembly having a raised positive stop lug being larger in size in width than the main portion of the hook assembly and so as to come into contact at the rear of the lure body and prevent passing through the lure body when inserted into the longitudal bore of the lure body.
b. A fishing lure having an elongated body having a first and second end in combination with having a longitudal bore extending along a linear axis from the first end to the second end in communication within the internal wall surfaces of said lure body providing a longitudal slot generally smaller in width than the longitudal bore and extending from the longitudal bore to the outer surface of the lure body and extending along the linear axis of said lure body from the first end to the second end. With the said longitudal bore being of equal size and shape with said main portion of the hook assembly so when the hook assembly is inserted into the longitudal bore until said raised positive stop lug comes to contact the rear of the lure body being prevented from passing through the longitudal bore of the lure body. The presence of friction from the longitudal bore and the inserted hook assembly being of equal size and shape will secure the combination and form a completed fishing lure to be fished.

2. The fishing lure body claimed in claim 1 additionally including a dive plane appendage on said lure body in which will have a slot in communication with said longitudal slot provided in the lure body as to provide a means for fishing line or leader to passthrough the lure body and dive plane appendage.
